(19) United States
(12) Patent Application Publication
(10) Pub. No.: US 2023/0034436 A1
(43) Pub. Date: Feb. 2, 2023

(54) QUANTUM CIRCUIT ARRANGEMENT

(71) Applicant: International Business Machines Corporation, Armonk, NY (US)

(72) Inventors: Albert Frisch, Stuttgart (DE); Harry Barowski, Schoenaich (DE); Dominik Steenken, Stuttgart (DE); David Bucher, Mindelheim (DE); Gawel Kus, Delft (NL); Isabel Haide, Karlsruhe (DE); Jan Müggenburg, Gummersbach (DE)

(21) Appl. No.: 17/366,640

(22) PCT Filed: Jan. 16, 2020
(86) PCT No.: PCT/IB2020/050341

§ 371 Date: Jul. 2, 2021

(30) Foreign Application Priority Data
Feb. 8, 2019 (EP) 19156139.8

(51) Int. Cl. G06N 10/60; G06N 10/20

(52) U.S. Cl. CPC G06N 10/60; G06N 10/20

(57) ABSTRACT

A quantum circuit arrangement with at least one quantum circuit for carrying out a computation on a quantum computer, the quantum circuit arrangement comprising at least a lookup structure being configured for determining a value of a defined function based on a variable represented by a set of qubits, and a binning structure being configured to identify a defined bin based on the variable, wherein the lookup structure is adapted to determine the value of the defined function based on the bin. Further a method implementable on a classical computer for compiling a quantum circuit arrangement with at least one quantum circuit for carrying out a computation on a quantum computer.

The present invention relates in general to data processing systems, in particular to a quantum circuit arrangement with at least one quantum circuit for carrying out a computation on a quantum computer as well as a method implementable on a classical computer for compiling a quantum circuit arrangement with at least one quantum circuit for carrying out a computation on a quantum computer.

### BACKGROUND

Quantum computers perform computations on the basis of quantum mechanics Significant speedups are possible to solve dedicated problems. A quantum algorithm is known in the state of the art to estimate features of the solution of a set of linear equations. Compared to classical algorithms for the same task, these algorithms can be as much as exponentially faster.

Linear equations, important in many fields of science and engineering, in realistic problems often are defined by very large matrices and thus require large amounts of data to be stored and handled. An example for applying linear equations is discretizing partial differential equations. Here classical computing may come to its limits concerning time and storage capabilities. Solving linear equations is therefore a task typically dedicated to quantum computers with their extraordinary computing speed.

The so-called HHL algorithm, described by Harrow, Aram W; Hassidim,

Avinatan; Lloyd, Seth (2009), ‘Quantum algorithm for solving linear systems of equations’, Physical Review Letters, 103(15), 150502, is capable of solving systems of linear equations with exponential speedup on a quantum computer. The HHL algorithm consists of several computational steps on data stored in quantum registers.

For a specific step of the HHL algorithm, known as controlled rotation, no efficient implementation is known up to this date, because in the original description of the HHL algorithm the authors supposed a solution for this step to be given.

Due to the quantum nature of stored data, classical computation cannot be applied, because a readout of a quantum state to a classical machine would be computationally expensive.

### SUMMARY

A quantum circuit arrangement with at least one quantum circuit for carrying out a computation on a quantum computer is proposed, the quantum circuit arrangement comprising at least a lookup structure being configured for determining a value of a defined function based on a variable represented by a set of qubits, and a binning structure being configured to identify a defined bin based on the variable. The lookup structure is adapted to determine the value of the defined function based on the bin.

Advantageously, a quantum circuit may be executed on a quantum register consisting several qubits for efficiently performing an HHL algorithm for solving linear equations. Compared to classical algorithms for the same task, the HHL algorithm solves the problem as much as exponentially faster.

According to a favourable embodiment of the invention, an efficient controlled rotation step in the HHL algorithm may advantageously be facilitated for applications where small errors can be tolerated.

Specifically, the embodiment allows for controllable parameters to set the level of precision dependent on the application and to reduce the introduced errors to arbitrarily small values on the cost of a number of quantum gates, which translates into algorithm runtime, and number of qubits used.

Typically, the overall HHL algorithm based on the proposed embodiment may be simulated to achieve a fidelity better than 99.999% and output probability of 20-30% on average for a certain set of parameters.

The embodiment of the invention is based on precomputed values of a lookup structure for a specific function and binning multiple values in a binning structure.

Precomputed values may be calculated on a classical computer with high precision. Any arbitrary classically computable function may be used, but the presented lookup structure may favourably be used for functions that are monotonically decreasing.

Therefore in case of the HHL algorithm the method may be reduced to functions 1/×and arcsin(1/×). The precalculation is carried out during compilation of the quantum circuit and does not increase the runtime of the quantum algorithm.

Binning multiple values allows to reduce the number of needed rotations that are carried out within the quantum circuit. An exponential amount of rotations in the exact case is reduced to a linear amount of rotations in the binning case. The binning method introduces a small error which is limited to a maximum value. The number of controlled rotations depends linearly on the overall eigenvalue precision, but scales exponentially with the choice of rotation precision.

Possible applications for using the proposed quantum circuit arrangement may favourably be, e.g., solving differential equations, least-squares fitting, classical perceptron, electromagnetic scattering or cubic spline interpolation.

According to a favourable embodiment of the inventive quantum circuit arrangement, the defined function may have a negative derivative with monotonically decreasing absolute value, which means that a monotonically decreasing function is used. Thus an advantageous lookup structure with an efficient and unique binning structure may be implemented in the embodiment.

According to a favourable embodiment of the inventive quantum circuit arrangement, a size of the bin may increase for increasing values of the variable. By this way the number of necessary rotations may be reduced for higher eigenvalues being used as input variable of the defined function.

According to a favourable embodiment of the inventive quantum circuit arrangement, a size of the bin may be based on the position of a first one qubit within the variable. The bin size is derived from a number of qubits, which may be defined by the number of qubits following the first one qubit within the variable. Thus, by using the first one qubit as the most significant qubit of the eigenvalue an efficient binning structure may be implemented using the proposed quantum circuit arrangement.

According to a favourable embodiment of the inventive quantum circuit arrangement, a size of the bin may be based on the position of a last one qubit within the variable. The bin size is derived from a number of qubits, which may be defined by the number of qubits following the first one qubit within the variable. Alternatively, depending on the approach of the binning structure, the last one qubit, which is the furthest one qubit to the right, may be used in similar embodiment. This may serve to cover different qubit orientations here (endianness). For a different endianness the first qubit will still be the first qubit, but from the other direction, from right instead from left.

According to a favourable embodiment of the inventive quantum circuit arrangement, the lookup structure may comprise at least one quantum gate arrangement for performing a controlled rotation of a further set of qubits. Thus an efficient implementation of an HHL algorithm may be achieved for computing on a quantum computer.

According to a favourable embodiment, the inventive quantum circuit arrangement may be configured for executing an HHL algorithm, further comprising a quantum phase estimation structure being configured for performing a quantum phase estimation, and further comprising an inverse quantum phase estimation structure being configured for performing an inverse quantum phase estimation, further comprising a lookup structure for performing a controlled rotation of a further set of qubits. By this way an efficient implementation of the full HHL algorithm on a quantum computer may be possible, executing all three major steps of the algorithm. Compared to classical algorithms for the same task, the HHL algorithm solves the problem as much as exponentially faster.

According to a favourable embodiment of the inventive quantum circuit arrangement, the function may comprise an arcsin(l/λ) function. The proposed function fulfils the requirement of a monotonous decreasing function in a favourable manner.

According to a favourable embodiment of the inventive quantum circuit arrangement, the quantum circuit may be configured for performing iterations over the variable through at least one sub qubit pattern of a pattern of a maximum size of the bin minus one. By introducing the sub qubit patterns the binning structure may advantageously be further improved concerning efficiency.

According to a favourable embodiment, the inventive quantum circuit arrangement may further be configured to be compiled on a classical computer. Thus a precomputation of values of the defined function for efficiently improving control processes of the quantum circuit arrangement may be possible. Therefore a significantly more efficient rotation step may be achieved in the HHL algorithm.

According to a favourable embodiment of the inventive quantum circuit arrangement, the quantum circuit may be configured with a negated control on a first qubit and a control on a second qubit, further comprising entangling an ancilla qubit that is in its ground state with the controls, and uncomputing the ancilla qubit. By this way a quantum circuit arrangement may be implemented with a reduced number of necessary quantum gates.

Uncomputation is a technique, used in reversible quantum circuits, for cleaning up temporary side effects on ancilla bits so they can be reused. Uncomputation is important to quantum computing. Whether or not intermediate effects have been uncomputed affects how states interfere with each other when measuring results.

According to a favourable embodiment of the inventive quantum circuit arrangement, the quantum circuit may be configured for using a second ancilla qubit, entangling with a multiple-controlled NOT operation being dependent on a sub qubit pattern comprising the two ancilla qubits, and performing controlled rotations conditional on the ancilla qubits and remaining combinations. The number of the remaining combinations amounts to 2(^{n-z}), where n is the number of qubits defining the corresponding bin and z is the length of the sub qubit pattern. In this embodiment the efficiency of the quantum circuit arrangement may further be improved.

Further a method is proposed implementable on a classical computer for compiling a quantum circuit arrangement with at least one quantum circuit for carrying out a computation on a quantum computer. The method comprises precomputing a set of values of a defined function based on a variable represented by a set of qubits for selected values of a variable; and generating at least one quantum circuit being configured for executing a controlled rotation by every value of the set of the precomputed values.

The inventive method is based on precomputed values of a lookup structure for a specific function and binning multiple values in a binning structure.

Precomputed values may be calculated on a classical computer with high precision. Any arbitrary classically computable function may be used, but the presented lookup method may favourably be used for functions that are monotonically decreasing.

Therefore in case of the HHL algorithm the method may be reduced to functions 1/×and arcsin(1/×). The precalculation is carried out during compilation of the quantum circuit and does not increase the runtime of the quantum algorithm.

According to a favourable embodiment, the inventive method may comprise predefining a set of bins, each value of the set of precomputed values corresponding to a bin of the defined set of bins Binning multiple values allows to reduce the number of needed rotations that are carried out within the quantum circuit. An exponential amount of rotations in the exact case is reduced to a linear amount of rotations in the binning case. The binning method introduces a small error which is limited to a maximum value. The number of controlled rotations depends linearly on the overall eigenvalue precision, but scales exponentially with the choice of rotation precision.

According to a favourable embodiment, the inventive method may further comprise executing an HHL algorithm, further comprising a quantum phase estimation structure being configured for performing a quantum phase estimation and an inverse quantum phase estimation structure being configured for performing an inverse quantum phase estimation, further a lookup structure for performing a controlled rotation of a further set of qubits. By this way an efficient implementation of the full HHL algorithm on a quantum computer may be possible, executing all three major steps of the algorithm.

Compared to classical algorithms for the same task, the HHL algorithm solves the problem as much as exponentially faster.

According to a favourable embodiment of the inventive method, the function may comprise an arcsin(1/λ) function. The proposed function fulfils the requirement of a monotonous decreasing function in a favourable manner.

According to a favourable embodiment of the inventive method, the quantum circuit may be configured for performing iterations over the variable through at least one sub qubit pattern of a pattern of a maximum size of the bin minus one. By introducing the sub qubit patterns the binning structure may advantageously be further improved concerning efficiency and error tolerance.

According to a favourable embodiment of the inventive method, the values of the variable may be selected according to the defined set of bins. Binning multiple values allows to reduce the number of needed rotations that are carried out within the quantum circuit. An exponential amount of rotations in the exact case is reduced to a linear amount of rotations in the binning case.

According to a favourable embodiment of the inventive method, a size of the bin may be based on the position of a first one qubit within the variable. The bin size is derived from a number of qubits, which may be defined by the number of qubits following the first one qubit within the variable. Thus, by using the first one qubit as the most significant qubit of the eigenvalue an efficient binning structure may be implemented using the proposed quantum circuit arrangement.

According to a favourable embodiment of the inventive method, a size of the bin may be based on the position of a last one qubit within the variable. The bin size is derived from a number of qubits, which may be defined by the number of qubits following the first one qubit within the variable. Alternatively, depending on the approach of the binning structure, the last one qubit, which is the furthest one qubit to the right, may be used in similar embodiment. This may serve to cover different qubit orientations here (endianness). For a different endianness the first qubit will still be the first qubit, but from the other direction, from right instead from left.

According to a favourable embodiment, the inventive method may further comprise the quantum circuit being configured with a negated control on a first qubit and a control on a second qubit, entangling an ancilla qubit that is in its ground state with the controls, and uncomputing the ancilla quibit. By this way a quantum circuit arrangement may be implemented with an efficiently reduced number of necessary to a quantum gate.

According to a favourable embodiment, the inventive method may further comprise using a second ancilla qubit, entangling with a multiple-controlled NOT operation being dependent on a sub qubit pattern comprising the two ancilla qubits, and performing controlled rotations conditional on the ancilla qubits and remaining combinations. The number of the remaining combinations amounts to 2(^{n-z}), where n is the number of qubits defining the corresponding bin and z the length of the sub qubit pattern.

In this embodiment the efficiency of the quantum circuit arrangement may further be improved.

Further, a favourable computer program product is proposed for compiling a quantum circuit arrangement with at least one quantum circuit for carrying out a computation on a quantum computer.

The computer program product comprises a computer readable storage medium having program instructions embodied therewith, the program instructions executable by the computer system to cause the computer system to perform a method comprising:

precomputing a set of values of a defined function based on a variable represented by a set of qubits for selected values of a variable; and generating at least one quantum circuit being configured for executing a controlled rotation by every value of the set of the precomputed values.

Further, a data processing system for execution of a data processing program is proposed, comprising computer readable program instructions for performing the method described above.

### BRIEF DESCRIPTION OF THE SEVERAL VIEWS OF THE DRAWINGS

The present invention together with the above-mentioned and other objects and advantages may best be understood from the following detailed description of the embodiments, but not restricted to the embodiments.

FIG. 1 depicts a quantum circuit arrangement for carrying out a computation on a quantum computer, being configured for executing an HHL quantum algorithm according to an embodiment of the invention.

FIG. 2 depicts a quantum circuit according to an embodiment of the invention.

FIG. 3 depicts a quantum circuit for controlled rotation of an eigenvalue register according to an embodiment of the invention.

FIG. 4 depicts a quantum circuit for controlled rotation of an eigenvalue register using a sub qubit pattern according to a further embodiment of the invention.

FIG. 5 depicts a flow chart for executing the HHL algorithm on a quantum circuit arrangement according to an embodiment of the invention.

FIG. 6 depicts a flow chart for preparing a lookup structure on the quantum circuit according to an embodiment of the invention.

FIG. 7 depicts a flow chart for determining binning positions within the binning structure according to an embodiment of the invention.

FIG. 8 depicts a flow chart for determining binning positions within the binning structure with sub qubit patterns according to a further embodiment of the invention.

FIG. 9 depicts a binning example according to an embodiment of the invention.

FIG. 10 depicts another binning example according to a further embodiment of the invention.

FIG. 11 depicts an example embodiment of a data processing system for executing a method according to the invention.

### DETAILED DESCRIPTION

In the drawings, like elements are referred to with equal reference numerals. The drawings are merely schematic representations, not intended to portray specific parameters of the invention. Moreover, the drawings are intended to depict only typical embodiments of the invention and therefore should not be considered as limiting the scope of the invention.

The illustrative embodiments described herein provide a quantum circuit arrangement with at least one quantum circuit for carrying out a computation on a quantum computer.

The illustrative embodiments may be used for the quantum circuit arrangement comprising at least a lookup structure being configured for determining a value of a defined function based on a variable represented by a set of qubits, and a binning structure being configured to identify a defined bin based on the variable, wherein the lookup structure is adapted to determine the value of the defined function based on the bin.

The illustrative embodiments are sometimes described herein using particular technologies only as an example for the clarity of the description.

According to the proposed quantum circuit arrangement for executing an HHL algorithm, an eigenvalue λmay be taken and a controlled rotation of arcsin(C/λ) applied to an ancilla qubit. An eigenvalue λmay be given with k qubits accuracy, assuming that the arcsin may be calculated to arbitrary accuracy and that the rotation around the y-axis does not add an additional error to the inverse. C is a constant which has to fulfil C ≤λₘᵢₙ , with λₘᵢₙ the smallest eigenvalue, and C may be set to 2^{-k}.

There may be defined msq as the bit-position of a most significant qubit (MSQ), furthest to the left in the qubit representation used, that is corresponding to the largest exponential of 2 set to 1 in the binary representation of λ. In this approach, for a given λ, e.g. in binary form λ=‘11100’ =2⁻¹ +2⁻² +2⁻³ =0.825. In the example, the msq is 1 (i.e. the highest qubit set is at 2⁻¹) and the total length k is 5. The next n qubits following the MSQ to define a bin in which 2^{k-(msq=n)} different binary patterns are stored. For each of the 2ⁿ binary patterns made up by the msq and the following n qubits, a precalculated inverse λₘᵢₙ/λis assigned to all binary patterns that fall into the corresponding bin. Hence, inside a bin, the error for the λ's is ϵ_{λ}≤2^{(msq+n)}/2 (equal only in the limit of a non-truncated qubit representation, i.e. infinite accuracy), if the midpoint of the bin is taken as an estimate. In the following, the limit in which the previous expressions are equal is used as the upper boundary to the error induced by the binning.

The error added by the rotation under the assumptions taken at the beginning is given by

$${ε}_{rot} = max ( \vert \frac{\frac{C}{\tilde{λ} - {ε}_{λ}} - \frac{C}{\tilde{λ}}}{\frac{C}{\tilde{λ} - {ε}_{λ}}} \vert )$$

where λis defined as the bin midpoint, because an arcsin-value may be computed and uncomputed via the rotation to arbitrary accuracy. Due to a symmetry around 0 only the region at λ≥0 is to be looked at. As the derivative of 1/×is negative and its absolute value monotonically decreasing in this definition range, the maximum error for each bin is induced at the left boundary of each bin (therefore \tilde{λ}ε_{λ}is used). Reformulating and inserting the expression for the error in λresults in

$${ε}_{rot} = max ( \vert \frac{{ε}_{λ}}{\tilde{λ}} \vert ) = max ( \vert \frac{{2}^{- ( m s q + n + 1 )}}{\tilde{λ}} \vert )$$

The MSQ m can be found by the relation

msq =|[log₂\tilde{λ}]|

Inserting this expression, one gets

εᵣₒₜ ≤2 ⁻⁽ⁿ⁺1)

n =[-log₂ (εᵣₒₜ) −1]

This means, that the number of qubits that are needed to be taken into account to reach a certain accuracy is independent of the register length k. Due to the binning, the number of controlled rotations is linear in the register size k. It is now (k−n+1)2ⁿ instead of 2^{k}.

The process of the quantum circuit design may be summarized by checking for a certain qubit pattern of length n and performing a controlled rotation by the corresponding angle θ=arcsin(C/λ), where C is a constant which has to fulfil C <λₘᵢₙ , with λₘᵢₙ the smallest eigenvalue, and C may be set to 2^{-k}.

It iterates over all MSQ (in total k−n+1) and shifts the controls that read out the n-qubit pattern one qubit further for each iteration. In order to prevent “wrong” rotations that occur due to qubits that shall be neglected because they are more than n qubits behind the MSQ, track is kept of the current MSQ and this is included as an additional control.

This means that for each MSQ a controlled NOT operation is performed on the msq garbage qubit which has negated control nodes for all qubits higher than the current MSQ and a control node for the current MSQ. After each MSQ the register is uncomputed. This register is referred to as |msq>in the following, where |msq>represents the corresponding qubit.

For example in a circuit for setting |msq>to m=2, before uncomputing, 2ⁿrotations may be performed conditional on |msq>.

For a further example, the numbers ‘101011’ and ‘111010’ shall be taken as eigenvalues λ. If taken k=6 and n=5, in both cases it would be checked for the substring ‘101’ in the middle of the qubit pattern. Instead it may be iterated through all possible substrings of the n-qubit pattern with the substring being of length z qubits. In this example it is checked for ‘101’ in the qubits 3 to 5. This result may be saved in a garbage bit using a Λ_{z}(σₓ) function, which is defined as a z-qubit controlled Toffoli gate according to implementation shown in paper by A. Barenco et al. (1995), ‘Elementary gates for quantum computation’, Physical Review A, 52, 3457. The notation means a z-qubit controlled execution of σₓ. Then it is iterated over all remaining 2^{n-z}combinations of the remaining qubits and a Λ_{n-z}(σ_{z}) gate used taking into account the result in the garbage qubit to rotate the ancillar qubit. Afterwards it is uncomputed with Λ_{z}(σₓ) and started with the next z-qubit pattern. Doing so effectively reuses the information that both numbers share the same sub qubit pattern and reduces the gate count. The 2ⁿΛₙ (σₓ) gates are replaced by 2^{z}(2Λ_{z}(σₓ) +2^{n-z}Λ_{n-z=l}(σₓ)) gates. Because the rotation has a corresponding operator that is in SU(2), the following approach may be used to perform a controlled rotation.

To implement this, a multiple-controlled operation is performed using no additional qubits. It is iterated k−n+1 times through 2ⁿcombinations and a controlled rotation performed. Using the z substring this may be performed using

(k−n+1)2^{z}(2Λ_{z}(σₓ)+2^{n-z}2[Λ_{n-z}(σₓ)+Λ₂(R_{y})]

A Λᵢ(U) gate requires (2ⁿ⁻−1)Λ₁(V or V^{†}) and (2ⁿ⁻¹−2)Λ₁(σₓ) gates. VorV^{†}is defined as V²^{²⁻ⁿ} =U, see reference A. Barenco et al. (1995), ‘Elementary gates for quantum computation’, Physical Review A, 52, 3457. All Λ₁ of SU(2) operators may be implemented with 4 to 5 gates, where for Ry rotations only 4 basic gates are used.

The gates that set the msq register are added. The idea of doing so is having a multiple-controlled NOT gate that checks for each iteration of the MSQ, if the next higher qubits are 0. Here a different approach may be used for testing if all qubits are 0 towards large k. At most k-n different bins are checked which may result in a gate count exponential in k using a favourable implementation.

However using few additional qubits, that don't even have to be in 0 for some implementations, the gate count may be brought to a linear or quadric dependency in k.

Now the gate count scales exponentially with n however as the accuracy of the rotation angle is independent of k, it is not necessary to scale n towards large register sizes.

For negative eigenvalues, one can think of turning the negative eigenvalue in its absolute value and perform another y-axis rotation of πbased on the sign-bit being set. To get the absolute value, one may bitwise invert and then increment this number (2′s complement). This may be done conditional on the sign bit.

Advantageously z-qubit patterns may be combined via several MSQs. The Λ_{z} gates still contribute the largest fraction to the gate count. If we vary the position of the qubit string z inside the register, the Λ_{z} gates may be re-used more often.

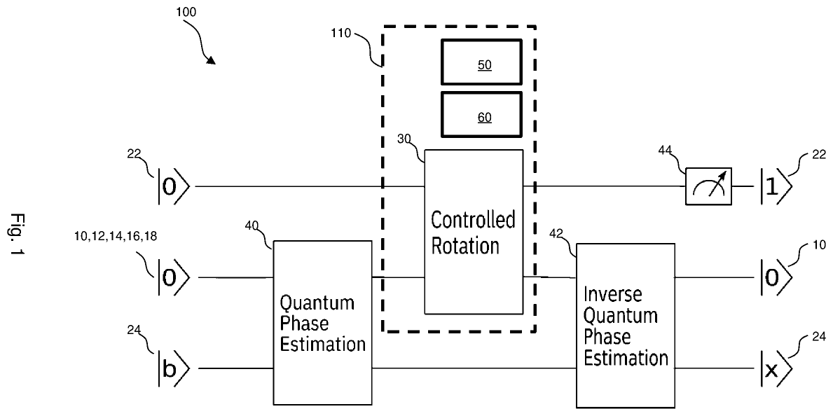

Implementations of the described quantum circuits and processes are described in the following FIGS. 1 to 10.

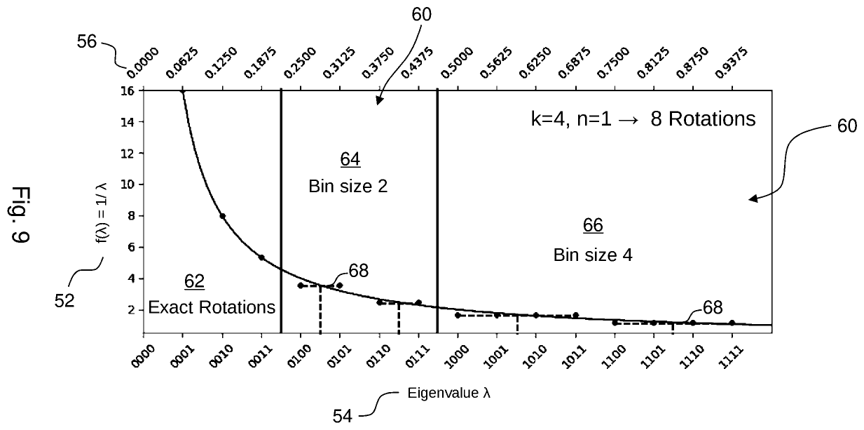

FIG. 1 depicts a quantum circuit arrangement 100 for carrying out a computation on a quantum computer, being configured for executing an HHL quantum algorithm according to an embodiment of the invention. The quantum circuit arrangement 100 with at least one quantum circuit 110 comprises a lookup structure 50 being configured for determining a value of a defined function based on a variable represented by a set of qubits 12, 14, 16, 18, and a binning structure 60 being configured to identify a defined bin 64, 66 (see FIG. 9) based on the variable. The lookup structure 50 is adapted to determine the value of the defined function based on the bin 64, 66 (see FIG. 9).

The quantum circuit arrangement 100 comprises further a quantum phase estimation structure 40 being configured for performing a quantum phase estimation, and an inverse quantum phase estimation structure 42 being configured for performing an inverse quantum phase estimation. The lookup structure 50 is configured for performing a controlled rotation of a further set of qubits 12, 14, 16, 18. The lookup structure 50 comprises at least one quantum gate arrangement 30 for performing the controlled rotation of the further set of qubits 12, 14, 16, 18.

In FIG. 1 input to the quantum phase estimation structure 40 is depicted as an eigenvalue register 10, comprising the qubits 12, 14, 16, 18 as well as a quantum register 24. The eigenvalue register 10 is in the ground state, the quantum state register 24 in state ‘lb>’. Controlled rotation is performed by the quantum gate arrangement 30 by means of an ancilla qubit 22, also in ground state. The output state of the ancilla qubit 22 is measured by the measurement operation 44. In FIG. 1 the output state of the ancilla qubit 22 is ‘|1>’, which means that the controlled rotation exhibits a successful result. The eigenvalue register 10 is after the inverse quantum phase estimation 42 again in the ground state. The quantum register 24 is in state ‘|x>’.

The quantum circuit arrangement 100 is configured to be compiled on a classical computer.

The quantum circuit arrangement 100 may be compiled on a classical computer for precomputing a set of values of the defined function based on a variable represented by a set of qubits 12, 14, 16, 18 for selected values of a variable. Then at least one quantum circuit 110 may be generated, being configured for executing a controlled rotation by every value of the set of the precomputed values.

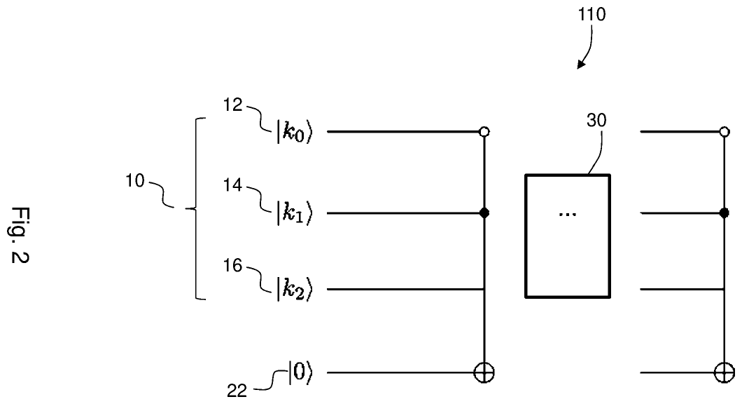

FIG. 2 depicts a quantum circuit 110 according to an embodiment of the invention. Qubits 12, 14, 16 of an eigenvalue register 10 together with an ancilla qubit 22 are an input to the controlled rotation process. To reduce the number of gates, the number of controls to a gate is reduced. Therefore the quantum circuit 110 is configured with a negated control (marked by an open circle) on a first qubit 12 and a control (marked by a filled circle) on a second qubit 14. Further the ancilla qubit 22 is entangled, that is in its ground state ‘0’ with the controls. Later, the ancilla qubit 22 is uncomputed and may be reused.

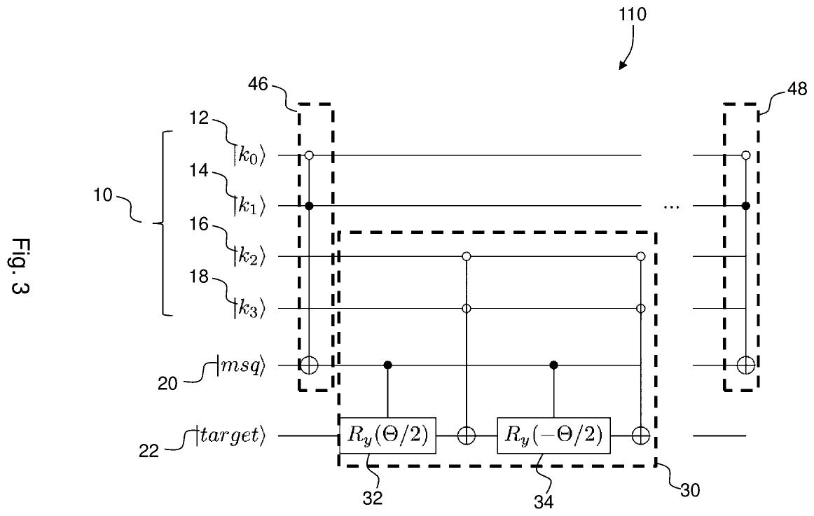

FIG. 3 depicts a quantum circuit 110 for controlled rotation of an eigenvalue register 10 according to an embodiment of the invention. Input to the rotation process is an eigenvalue register 10 with qubits 12, 14, 16, 18, further a first one qubit 20 (|msq>) as a position of a most significant qubit, as well as an ancilla qubit 22 (target). The first one qubit 20 is determined in box 46 and is used to determine a size of the bin 64, 66 (see FIG. 9), based on the position of a first one qubit 20 within the variable.

Alternatively a size of the bin 64, 66 may be based on the position of a last one qubit within the variable. The bin size 64, 66 is derived from a number of qubits, which may be defined by the number of qubits following the first one qubit within the variable. This may serve to cover different qubit orientations here (endianness). For a different endianness the first qubit will still be the first qubit, but from the other direction, from right instead from left.

In FIG. 3 an example of a rotation process for an eigenvalue, which equals to ‘0100’, corresponding to a binary fraction of 0.25, and which is stored in the qubits 12, 14, 16, 18 of the eigenvalue register 10, is shown. Controlled rotation is performed for an angle θ, which may be determined from the lookup structure 50 as θ=arcsin(1/λThe rotation is performed by the quantum gate arrangement 30 in two steps 32 and 34 with an angle of θ/2 and −θ/2, respectively. Before uncomputing the first one qubit 20 in box 48, other rotations of the eigenvalues ‘01**’ are performed, where ‘**’ is representing combinations of ‘0’ and ‘1’.

The method thus comprises the quantum circuit 110 being configured with a negated control on a first qubit 12 and a control on a second qubit 14, entangling an ancilla qubit 22 that is in its ground state with the controls, and uncomputing the ancilla qubit 22.

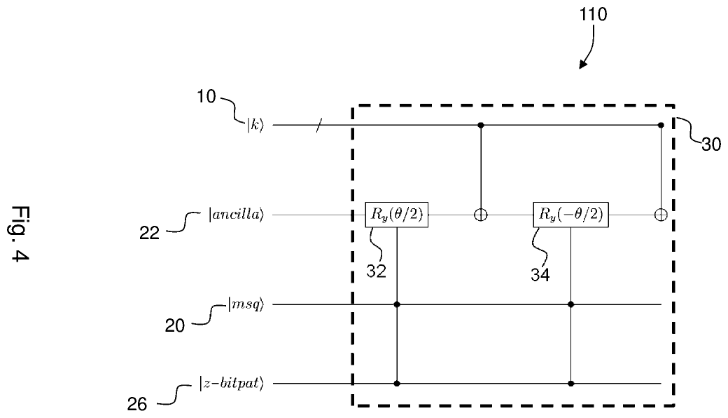

FIG. 4 depicts a quantum circuit 110 for controlled rotation of an eigenvalue register 10 using a sub qubit pattern according to a further embodiment of the invention. This embodiment may implement a further improvement. The quantum circuit 110 may be configured for using a second ancilla qubit 26, entangling with a multiple-controlled NOT gate being dependent on a sub qubit pattern comprising the two ancilla qubits 22, 26, and performing controlled rotations conditional on the ancilla qubits 22, 26 and remaining combinations.

Here the quantum circuit 110 is configured for performing iterations over the variable through at least one sub qubit pattern of a pattern of a maximum size of the bin 64, 66 minus one. Inputs to the quantum gate arrangement 30 for a controlled rotation are the eigenvalue register 10 with qubits, an ancilla qubit 22 (ancilla), a first one qubit 20 (msq) and a qubit 26 of the sub qubit pattern (z-bitpat), which is the second ancilla qubit. Controlled rotation is performed, as with the embodiment shown in FIG. 3, with an angle θ, determined from a lookup structure 50.

For the embodiment shown in FIG. 4, the circuit creation routine comprises for each first one qubit 20: the first one qubit 20 is entangled. Then for each sub qubit pattern a first loop comprises: the sub qubit pattern qubit 26 is entangled, followed by a step: for each (n-z) pattern, where n is the size of the bin and z is the size of the sub qubit pattern, a second loop comprises: a conditional rotation is performed on the sub qubit pattern qubit 26, the first one qubit 20 and the n-z qubits of the eigenvalue register 10. Then the sub qubit pattern qubit 26 is uncomputed and the first loop ended. Finally the first one qubit 20 is uncomputed.

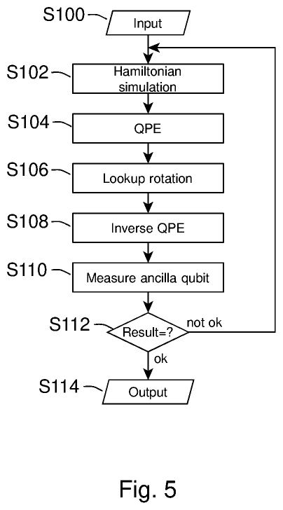

FIG. 5 depicts a flow chart for executing the HHL algorithm on a quantum circuit arrangement according to an embodiment of the invention, depicted in FIG. 1. Execution of the HHL algorithm is started with transferring input parameters to the quantum circuit arrangement in step S100, followed by a Hamiltonian simulation in step S102. According to FIG. 1 the quantum phase estimation is carried out by the quantum phase estimation structure in step S104. Then the lookup structure may serve for delivering the appropriate rotation angles in order to carry out the controlled rotation in step S106. Having accomplished the controlled rotation the inverse quantum phase estimation is carried out by the inverse quantum phase estimation structure, step S108. Then the ancilla qubit may be measured by the measurement unit in step S110. In step S112 it is checked, if the result is successful, which means that the ancilla qubit delivers ‘1’. If this is the case, the output of the HHL algorithm is delivered in step S114. If not, then the loop returns to step S102, for executing a new Hamiltonian simulation.

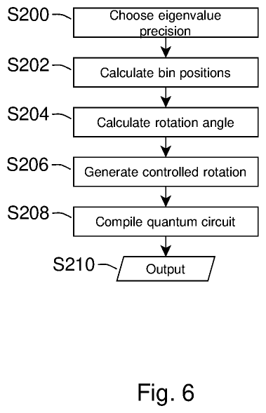

In FIG. 6 a flow chart for preparing a lookup structure on the quantum circuit according to an embodiment of the invention is depicted. This process step may be carried out on a classical computer to precompute the set of values of the defined function, e.g. the arcsin(1/λ) function. The preparation process is started by choosing a precision for eigenvalue determination in step S200, where the precision is determined by the number of qubits of the eigenvalue register, |k>. Next in step S202 bin positions are calculated with the established binning structure. Then, in step S204, the rotation angle is determined using the defined function. With this rotation angle the controlled rotation is executed on the eigenvalues in step S206, followed by compiling the quantum circuit on the classical computer in step S208. The result of the preparation process is given for output in step S210.

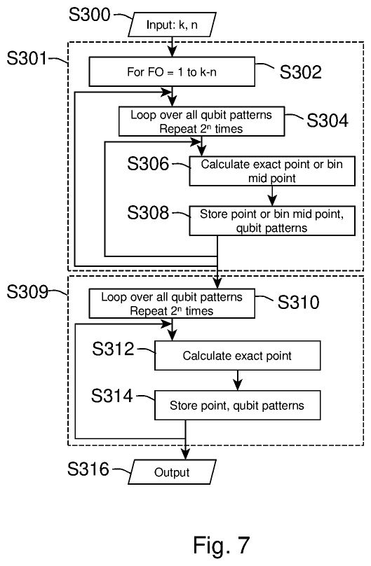

FIG. 7 depicts a flow chart for determining binning positions within the binning structure according to an embodiment of the invention. Input for the process are the size of the eigenvalue register, k, and a length of a qubit pattern, n, given in step S300. Then within the subprocess S301, an outer loop is carried out for a position of a first one qubit, FO, as the most significant qubit within the first k-n qubits of the eigenvalue register, step S302. An inner loop is carried out over all qubit patterns, step S304, repeating 2ⁿ times. Within the loop an exact point for a rotation angle is calculated or a bin mid- point, step S306, followed by storing the point or the mid-point, as well as the qubit patterns, step S308. In the subprocess S301, a binning procedure is carried out in a loop ranging from 1 to k-n.

Next, if the loop over the first one qubit is ended, within the subprocess S309, a loop again is carried out over all qubit patterns, step S310, repeating 2ⁿ times. Within the loop an exact point for a rotation angle is calculated, step S312, followed by storing the point, as well as the qubit patterns, step S314. In the subprocess S309, no first one qubit is determined and no binning procedure is carried out.

Then an output is given in step S316.

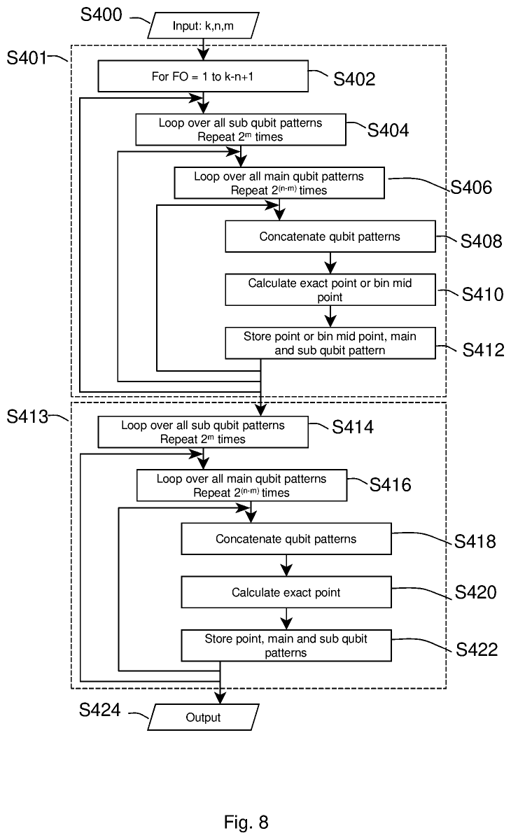

FIG. 8 depicts a flow chart for determining binning positions within the binning structure with sub qubit patterns according to a further embodiment of the invention. Input for the process are a size of the eigenvalue register, k, a length of a qubit pattern, n, and a length of a sub qubit pattern, m, given in step S400. Thus a length of a main qubit pattern is given by n-m.

Within the subprocess S401, an outer loop is carried out for a position of a first one qubit as the most significant qubit within the first k−n+1 qubits of the eigenvalue register, step S402. An inner loop is carried out over all sub qubit patterns, step S404, repeating 2^{m} times. A next inner loop is carried out over all main qubit patterns, step S406, repeating 2^{n-m} times. Within the loops the qubit patterns are concatenated in step S408. Next an exact point for a rotation angle is calculated or a bin mid-point, step S410, followed by storing the point or the mid-point, as well as the main qubit pattern and the sub qubit pattern, step S412. In the subprocess S401, a binning procedure is carried out in a loop ranging from 1 to k-n.

Next, if the outer loop over the first one qubit is ended, within the subprocess S413, an inner loop is carried out over all sub qubit patterns, step S414, repeating 2^{m} times. A next inner loop is carried out over all main qubit patterns, step S416, repeating 2^{n-m} times. Within the loops the qubit patterns are concatenated in step S418. Next an exact point for a rotation angle is calculated, step S420, followed by storing the point, as well as the main qubit pattern and the sub qubit pattern, step S422. In the subprocess S413, no first one qubit is determined and no binning procedure is carried out.

Then an output is given in step S424.

FIG. 9 depicts a binning example according to an embodiment of the invention. There are shown 1/λ— values 52 as a function of eigenvalues λ54. A size of the eigenvalue register is k=4, so eigenvalues λ54 range from ‘0000’ to ‘1111’, or as binary fractions 56 from 0.0000 to 0.9375. Thus for each eigenvalue λ54 a corresponding 1/λ— value 52 may be chosen from the curve in order to determine an angle θfor a controlled rotation by calculating arcsin(1λ).

According to the flow chart in FIG. 7 for a first one qubit of one and a qubit pattern of length one, i.e. n=1, the qubit pattern ‘1’ may be found e.g. in the value qubits of ‘11**’ four times, which means a bin size 68 of four will be derived. This is depicted in the field 66 of bin size four. The bin size is indicated by the bar 68.

For a first one qubit of two, the qubit pattern ‘1’ may be found e.g. in the value qubits of ‘011*’ two times, which means a bin size 68 of two will be derived. This is depicted in the field 64 of bin size two. The bin size is indicated by the bar 68.

Thus a size of the bin 64, 66 increases for increasing values of the eigenvalue λ54. The method comprises predefining a set of bins 64, 66, each value of the set of precomputed values corresponding to a bin 64, 66 of the defined set of bins 64, 66. The values of the variable are selected according to the defined set of bins 64, 66.

For the rest of eigenvalues λ54 the exact rotation values 62 may be chosen from the curve in FIG. 9. Thus a total of eight controlled rotations may be executed for the example of a size of an eigenvalue register of k=4 and a pattern length of n=1.

The process of choosing an angle θfor the controlled rotation from the binning structure 60 shown in FIG. 9 is carried out in the lookup structure 50 (see FIG. 1).

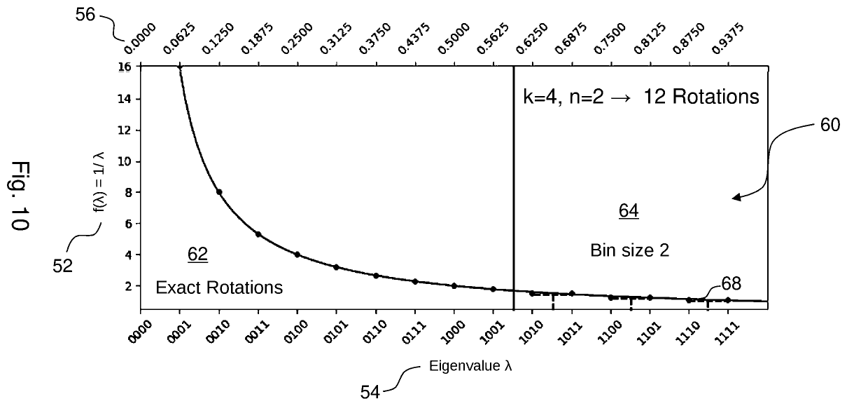

FIG. 10 depicts another binning example according to a further embodiment of the invention for comparison. In this case an example of a size of an eigenvalue register of k=4 and a pattern length of n=2 is chosen.

According to the flow chart in FIG. 7 for a first one qubit of one and a qubit pattern of length two, i.e. n=2, the qubit pattern ‘11’ may be found e.g. in the value qubits of ‘111*’ two times, which means a bin size 68 of two may be chosen. This is depicted in the field 64 of bin size two. The bin size is indicated by the bar 68. The same applies to a qubit pattern ‘10’, which may be found in ‘110*’ two times.

For the rest of eigenvalues λ54 the exact values may be chosen from the curve in FIG. 10. Thus a total of twelve controlled rotations may be executed for the example of a size of an eigenvalue register of k=4 and a pattern length of n=2.

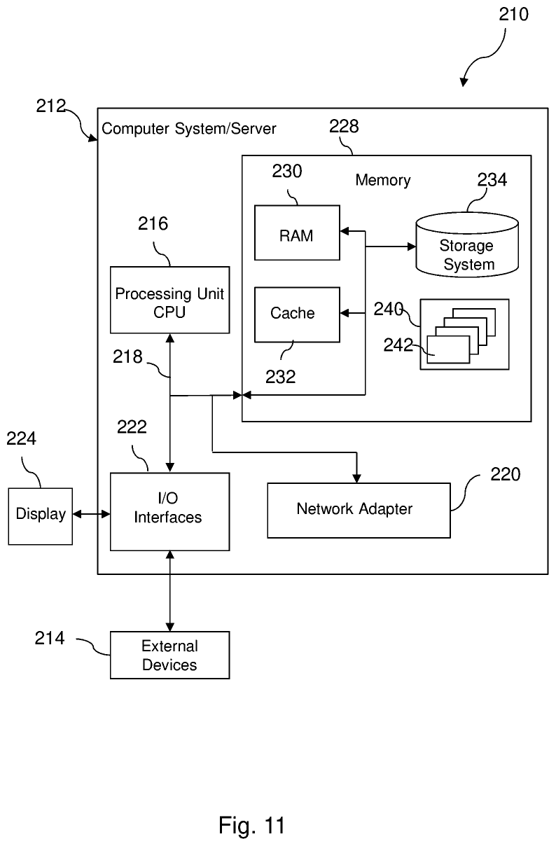

Referring now to FIG. 11, a schematic of an example of a data processing system 210 is shown. Data processing system 210 is only one example of a suitable data processing system and is not intended to suggest any limitation as to the scope of use or functionality of embodiments of the invention described herein. Regardless, data processing system 210 is capable of being implemented and/or performing any of the functionality set forth herein above.

In data processing system 210 there is a computer system/server 212, which is operational with numerous other general-purpose or special-purpose computing system environments or configurations. Examples of well-known computing systems, environments, and/or configurations that may be suitable for use with computer system/server 212 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 212 may be described in the general context of computer system executable instructions, such as program modules, being executed by a computer system. Generally, program modules may include routines, programs, objects, components, logic, data structures, and so on that perform particular tasks or implement particular abstract data types. Computer system/server 212 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 11, computer system/server 212 in data processing system 210 is shown in the form of a general-purpose computing device. The components of computer system/server 212 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 212 typically includes a variety of computer system readable media. Such media may be any available media that is accessible by computer system/server 212, and it includes both volatile and non-volatile media, removable and non-removable media.

System memory 228 can include computer system readable media in the form of volatile memory, such as random access memory (RAM) 230 and/or cache memory 232. Computer system/server 212 may further include other removable/non-removable, volatile/non-volatile computer system storage media. By way of example only, storage system 234 can be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 242, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 242 generally carry out the functions and/or methodologies of embodiments of the invention as described herein.

Computer system/server 212 may also communicate with one or more external devices 214 such as a keyboard, a pointing device, a display 224, etc.; one or more devices that enable a user to interact with computer system/server 212; and/or any devices (e.g., network card, modem, etc.) that enable computer system/server 212 to communicate with one or more other computing devices. Such communication can occur via Input/Output (I/O) interfaces 222. Still yet, computer system/server 212 can communicate with one or more networks such as a local area network (LAN), a general wide area network (WAN), and/or a public network (e.g., the Internet) via network adapter 220. As depicted, network adapter 220 communicates with the other components of computer system/server 212 via bus 218. It should be understood that although not shown, other hardware and/or software components could be used in conjunction with computer system/server 212. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non- exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the ‘C’ programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special-purpose hardware-based systems that perform the specified functions or acts or carry out combinations of special-purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### REFERENCE NUMERALS

10 quantum circuit

12 qubit

14 qubit

16 qubit

18 qubit

20 msq

22 ancilla qubit

24 quantum register

26 second ancilla qubit

30 quantum gate arrangement for controlled rotation

32 =rotation

34 −rotation

40 quantum phase estimation structure

42 inverse quantum phase estimation structure

44 measurement operation

46 computing first one

48 uncomputing first one

50 lookup structure

52 1/λvalue

54 eigenvalues

56 binary fraction of eigenvalue

60 binning structure

62 exact rotation

64 bin size 2

66 bin size 4

68 bin size

100 quantum circuit arrangement

110 quantum circuit

210 data processing system

212 computer system/server

214 external devices

216 CPU / data processing unit

218 I/O Bus

220 network adapter

222 I/O interfaces

224 display

228 memory

230 RAM

232 cache

234 storage system

240 program/utility

242 program modules

θrotation angle

S100 Transfer input parameters to quantum circuit

S102 Hamiltonian simulation

S104 Quantum phase estimation

S106 Lookup rotation angles

S108 Inverse quantum phase estimation

S110 Measure ancilla qubit

S112 Check if result is successful

S114 Deliver output result

S200 Choose precision for eigenvalue determination

S202 Calculate bin position

S204 Calculate rotation angle

S206 Generate controlled rotation

S208 Compile quantum circuit on classical computer

S210 Output of result of preparation process

S300 Input size of eigenvalue register k, and length of qubit pattern n

S301 Subprocess binning procedure

S302 Outer loop for a position of a first one qubit

S304 Inner loop over all qubit patterns, repeating 2ⁿ times

S306 Calculate exact point or bin midpoint for rotation angle

S308 Store point or bin midpoint, and qubit patterns

S309 Subprocess

S310 Loop over all qubit patterns, repeating 2ⁿ times

S312 Calculate exact point for rotation angle

S314 Store point, and qubit patterns

S316 Output of result

S400 Input size of eigenvalue register k, length of qubit pattern n, and length of sub qubit pattern m

S401 Subprocess binning procedure

S402 Outer loop for a position of a first one qubit

S404 Inner loop over all sub qubit patterns, repeating 2^{m} times

S406 Next inner loop over all main qubit patterns, repeating 2^{(n-m)} times

S408 Concatenate qubit patterns

S410 Calculate exact point or bin midpoint for rotation angle

S412 Store point or bin midpoint, main and sub qubit patterns

S413 Subprocess

S414 Inner loop over all sub qubit patterns, repeating 2^{m} times

S416 Next inner loop over all main qubit patterns, repeating 2^{(n-m)} times

S418 Concatenate qubit patterns

S420 Calculate exact point for rotation angle

S422 Store point, and main and sub qubit patterns

S424 Output of result

1. A quantum circuit arrangement with at least one quantum circuit for carrying out a computation on a quantum computer, the quantum circuit arrangement comprising:
a lookup structure that determines a value of a defined function based on a variable represented by a set of qubits;
a binning structure that identifies a determined bin based on the variable, wherein the lookup structure is adapted to determine the value of the defined function based on the bin.

2. The quantum circuit arrangement according to claim 1, the defined function having a negative derivative with monotonically decreasing absolute value.

3. The quantum circuit arrangement according to claim 1, wherein a size of the bin increases for increasing values of the variable.

4. The quantum circuit arrangement according to claim 1, wherein a size of the bin is based on the position of a first one qubit within the variable, wherein the size of the bin is defined by the number of one's following the first one qubit within the variable.

5. The quantum circuit arrangement according to claim 1, wherein a size of the bin is based on the position of a last one qubit within the variable, wherein the size of the bin is defined by the number of one's preceding the first one qubit within the variable.

6. The quantum circuit arrangement according to claim 1, wherein the lookup structure comprises at least one quantum gate arrangement for performing a controlled rotation of a further set of qubits.

7. The quantum circuit arrangement according to claim 1, being configured for executing an HHL algorithm, further comprising a quantum phase estimation structure being configured for performing a quantum phase estimation, and further comprising an inverse quantum phase estimation structure being configured for performing an inverse quantum phase estimation, further comprising a lookup structure for performing a controlled rotation of a further set of qubits.

8. The quantum circuit arrangement according to claim 1, wherein the function comprises an arcsin(1/λ) function.

9. The quantum circuit arrangement according to claim 1, the quantum circuit performing iterations over the variable through at least one sub qubit pattern of a pattern of a maximum size of the bin minus one.

10. The quantum circuit arrangement according to claim 1, further being configured to be compiled on a classical computer.

11. The quantum circuit arrangement according to claim 1, the quantum circuit being configured with a negated control on a first qubit and a control on a second qubit, further comprising:
entangling an ancilla qubit that is in its ground state with the controls; and
uncomputing the ancilla qubit.

12. The quantum circuit arrangement according to claim 11, the quantum circuit being configured for:
using a second ancilla qubit;
entangling with a multiple-controlled NOT operation being dependent on a sub qubit pattern comprising the two ancilla qubits; and
performing controlled rotations conditional on the ancilla qubits and remaining combinations.

13. A method implementable on a classical computer for compiling a quantum circuit arrangement with at least one quantum circuit for carrying out a computation on a quantum computer, the method comprising:
precomputing a set of values of a defined function based on a variable represented by a set of qubits for selected values of a variable; and
generating at least one quantum circuit being configured for executing a controlled rotation by every value of the set of the precomputed values.

14. The method according to claim 13, wherein the method comprises predefining a set of bins, each value of the set of precomputed values corresponding to a bin of the defined set of bins.

15. The method according to claim 13, wherein the method further comprises executing an HHL algorithm, further comprising a quantum phase estimation structure being configured for performing a quantum phase estimation and an inverse quantum phase estimation structure being configured for performing an inverse quantum phase estimation, further a lookup structure for performing a controlled rotation of a further set of qubits.

16. The method according to any one of claims 13, wherein the function comprises an arcsin(1/λ) function.

17. The method according to any one of the claims 13, wherein the quantum circuit is configured for performing iterations over the variable through at least one sub qubit pattern of a pattern of a maximum size of the bin minus one.

18. The method according to any one of the claims 13, wherein the values of the variable are selected according to the defined set of bins.

19. The method according to any one of the claims 13, wherein a size of the bin is based on the position of a first one qubit within the variable, wherein the size of the bin is defined by the number of one's following the first one qubit within the variable.

20. The method according to any one of the claims 13, wherein a size of the bin is based on the position of a last one qubit within the variable, wherein the size of the bin is defined by the number of one's preceding the first one qubit within the variable.

21. The method according to any one of the claims 13, further comprising the quantum circuit being configured with a negated control on a first qubit and a control on a second qubit; and
entangling an ancilla qubit that is in its ground state with the controls, uncomputing the ancilla quibit.

22. The method according to claim 21, further comprising:
using a second ancilla qubit;
entangling with a multiple-controlled NOT operation being dependent on a sub qubit pattern comprising the two ancilla qubits; and
performing controlled rotations conditional on the ancilla qubits and remaining combinations.

23. A computer program product for compiling a quantum circuit arrangement with at least one quantum circuit for carrying out a computation on a quantum computer, the computer program product comprising a computer readable storage medium having program instructions embodied therewith, the program instructions executable by the computer system to cause the computer system to perform a method comprising:
precomputing a set of values of a defined function based on a variable represented by a set of qubits for selected values of a variable;
generating at least one quantum circuit being configured for executing a controlled rotation by every value of the set of the precomputed values.

24. A data processing system for execution of a data processing program comprising computer readable program instructions for performing a method implementable on a classical computer for compiling a quantum circuit arrangement with at least one quantum circuit for carrying out a computation on a quantum computer, the method comprising:
precomputing a set of values of a defined function based on a variable represented by a set of qubits for selected values of a variable; and
generating at least one quantum circuit being configured for executing a controlled rotation by every value of the set of the precomputed values.
